(19) United States
(12) Patent Application Publication
(10) Pub. No.: US 2012/0101889 A1
(43) Pub. Date: Apr. 26, 2012

(54) COUPON SELECTION SUPPORT APPARATUS, COUPON SELECTION SUPPORT SYSTEM, COUPON SELECTION SUPPORT METHOD, AND PROGRAM

(76) Inventors: Yoshinori KURATA, Ibaraki (JP); Junichiro Tsuji, Kanagawa (JP); Hiroshi Nakayama, Chiba (JP); Shouichi Doi, Kanagawa (JP); Masahiro Morita, Kanagawa (JP)

(21) Appl. No.: 13/107,468

(22) Filed: May 13, 2011

(30) Foreign Application Priority Data
May 19, 2010 (JP) P2010-115347

(51) Int. Cl. G06Q 30/02

(52) U.S. Cl. 705/14.25

(57) ABSTRACT

Disclosed herein is a coupon selection support apparatus including: a commercial product information acquisition block configured to acquire commercial product information associated with a commercial product subject to a coupon; a commercial product analysis block configured to analyze a commercial product subject to a coupon; a usage log acquisition block configured to acquire a coupon usage log of each user; a log analysis block configured to analyze a purchase timing of a commercial product purchased by each user in the past; and a selection support block configured to predict a next purchase timing of the commercial product to preferentially present, at the next purchase timing, a coupon for the commercial product and coupons related with the coupon by the commercial product analysis block.

### BACKGROUND OF THE INVENTION

1. Field of the Invention

The present invention relates to a coupon selection support apparatus, a coupon selection support system, a coupon selection support method, and a program.

2. Description of the Related Art

Sale promotion business models have been gaining popularity in which coupon tickets for enabling users to get a discount of the product price at the time of purchasing a commercial product and get the provision of additional services at the time of purchasing a commercial product are used. Recently, scenes of distributing coupon tickets on the street are frequently seen in inner-city and downtown areas. Also, some large-scale restaurant groups and retailer groups are distributing coupon tickets through networks including the Internet. Further, separate from commercial product manufacturers and service providers (hereafter referred to as manufacture and sale businesses), dedicated coupon issuing businesses are appearing that issue coupon tickets consigned by manufacture and sales businesses. Thus, recently, various types of businesses based on coupon tickets are being spread out (hereafter referred to as coupon businesses) through which large amounts and types of coupon tickets have begun to be distributed on the market.

With respect to these coupon businesses, Japanese Patent Laid-Open No. 2006-252160 (hereinafter referred to as Patent Document 1) below discloses a technology associated with a coupon issuing system for providing coupons by use of networks, such as the Internet. Patent Document 1 describes a method of analyzing user desires and user purchase logs to provide users with the information about coupon tickets suitable to individual users. In addition, Patent Document 1 describes the configuration of a system for recording the information about coupon tickets offered to users to an IC (Integrated Circuit) card to enable the users to get services by use of the coupon ticket information recorded to the IC card.

### SUMMARY OF THE INVENTION

The system described in Patent Document 1 above has a section for providing a user with coupon tickets of a commercial product frequently purchased by the user and commercial products related with this commercial product. In another word, it can be said that the system described in Patent Document 1 above provides a section for issuing coupon tickets of commercial products of user preference. However, the system described in Patent Document 1 above does not take user's purchase habit into account. For example, assume that there be user A who has a purchase habit of buying tissue boxes about one in two weeks. The system described in Patent Document 1 above may provide user A with the coupon tickets for tissue boxes at the time user A buys tissue boxes.

However, at that time, user A may be provided with many coupon tickets of other frequently purchased commercial products than tissue boxes. The system described in Patent Document 1 above does not present the coupon tickets of tissue boxes in a manner easy for user A to find from other coupon tickets. This causes user A to look for issue box coupon tickets from the beginning. For example, user A may have to search for desired coupon tickets by specifying tissue paper as a keyword. Thus, the system described in Patent Document 1 above is not convenient for users buying daily-use articles to use. Therefore, the present invention addresses the above-identified and other problems associated with related-art methods and apparatuses and solves the addressed problems by providing a coupon selection support apparatus, a coupon selection support system, a coupon selection support method, and a program that are configured, in a novel and improved manner, to enable easy search for the coupons of commercial products desired by a user at a certain time by considering the purchase habit of the user.

In carrying out the invention and according to one embodiment thereof, there is provided a coupon selection support apparatus. This coupon selection support apparatus has a commercial product information acquisition block configured to acquire commercial product information associated with a commercial product subject to a coupon; a commercial product analysis block configured to analyze a commercial product subject to a coupon on the basis of the commercial product information acquired by the commercial product information acquisition block to relate coupons of subject commercial products having associated commercial product information with each other; a usage log acquisition block configured to acquire a coupon usage log of each user; a log analysis block configured to analyze a purchase timing of a commercial product purchased by each user in the past on the basis of a usage log acquired by the usage log acquisition block; and a selection support block configured to predict a next purchase timing of the commercial product from a result of the analysis executed by the log analysis block for each user to preferentially present, at the next purchase timing, a coupon for the commercial product and coupons related with the coupon by the commercial product analysis block.

In the above-mentioned coupon selection support apparatus, the commercial product analysis block may be configured to detect a group of commercial products including substantially a same expression in the commercial product information to relate a plurality of coupons corresponding to the group of commercial products with each other.

In the above-mentioned coupon selection support apparatus, the commercial product analysis block may be configured to detect a first group of commercial products including substantially a same expression in the commercial product information and a second group of commercial products belonging to substantially a same price zone from among the first group of commercial products to relate a plurality of coupons corresponding to the second group of commercial products with each other.

In the above-mentioned coupon selection support apparatus, the log analysis block may be configured to analyze a purchase timing with which each user purchased a commercial product in the past to detect a purchase cycle of a commercial product belonging to the group of commercial products, thereby predicting a next purchase timing of the commercial product belonging to the group of commercial products.

In carrying out the invention and according to another embodiment thereof, there is provided a coupon selection support system. This coupon selection support system has a server apparatus and a client apparatus. The server apparatus has a commercial product information acquisition block configured to acquire commercial product information associated with a commercial product subject to a coupon; a commercial product analysis block configured to analyze a commercial product subject to a coupon on the basis of the commercial product information acquired by the commercial product information acquisition block to relate coupons of subject commercial products having associated commercial product information with each other; and a transmission block configured to transmit information about the coupons related with each other by the commercial product analysis block and commercial product information associated with a commercial product subject to a coupon to a client apparatus. The client apparatus has a reception block configured to receive information about the coupons related with each other by the commercial product analysis block and commercial product information associated with a commercial product subject to a coupon from the server apparatus; a usage log acquisition block configured to acquire a coupon usage log of each user; a log analysis block configured to analyze a purchase timing of a commercial product purchased by each user in the past on the basis of a usage log acquired by the usage log acquisition block; and a selection support block configured to predict a next purchase timing of the commercial product from a result of the analysis executed by the log analysis block for each user to preferentially present, at the next purchase timing, a coupon for the commercial product and coupons related with the coupon by the commercial product analysis block.

In carrying out the invention and according to still another embodiment thereof, there is provided a coupon selection support method. This coupon selection support method has the steps of acquiring commercial product information associated with a commercial product subject to a coupon; analyzing a commercial product subject to a coupon on the basis of the commercial product information acquired at the commercial product information acquisition step to relate coupons of subject commercial products having associated commercial product information with each other; acquiring a coupon usage log of each user; analyzing a purchase timing of a commercial product purchased by each user in the past on the basis of a usage log acquired at the usage log acquisition step; and predicting a next purchase timing of the commercial product from a result of the analysis executed at the log analysis step for each user to preferentially present, at the next purchase timing, a coupon for the commercial product and coupons related with the coupon at the commercial product analysis step.

In carrying out the invention and according to yet another embodiment thereof, there is provided a computer program. This computer program makes a computer realize the functions of acquiring commercial product information associated with a commercial product subject to a coupon; analyzing a commercial product subject to a coupon on the basis of the commercial product information acquired by the commercial product information acquisition function to relate coupons of subject commercial products having associated commercial product information with each other; acquiring a coupon usage log of each user; analyzing a purchase timing of a commercial product purchased by each user in the past on the basis of a usage log acquired by the usage log acquisition function; and predicting a next purchase timing of the commercial product from a result of the analysis executed by the log analysis function for each user to preferentially present, at the next purchase timing, a coupon for the commercial product and coupons related with the coupon by the commercial product analysis function.

Further, in order to solve the problems described above, a recording medium is provided in which the above-mentioned computer program is readably stored, as a different embodiment of the invention.

As described above and according to the embodiments of the invention, a user can easily search for desired coupon tickets subject to commercial products that the user desires to buy at certain point of time.

### BRIEF DESCRIPTION OF THE DRAWINGS

FIG. 1 is a schematic diagram illustrating a system configuration of a coupon management system practiced as a first embodiment of the invention;

FIG. 2 is a block diagram illustrating a functional configuration of a coupon management server practiced as the first embodiment;

FIG. 3 is a diagram for describing a data structure of a coupon database practiced with the first embodiment;

FIG. 4 is a diagram for describing a data structure of a series coupon database practiced as the first embodiment;

FIG. 5 is a diagram illustrating a data structure (a hierarchical structure) of the series coupon database practiced as the first embodiment;

FIG. 6 is a diagram for describing a data structure of a coupon usage log database practiced as the first embodiment;

FIG. 7 is a diagram illustrating a data structure of another coupon usage log database practiced as the first embodiment of the invention;

FIG. 8 is a diagram illustrating a coupon score database practiced as the first embodiment of the invention;

FIG. 9 is a flowchart indicative of a processing flow of coupon usage scenario practiced as the first embodiment;

FIG. 10 is a flowchart indicative of a processing flow of a coupon analysis module practiced as the first embodiment;

FIG. 11 is a diagram for describing processing of correcting a notation fluctuation of coupon meta information in the processing flow of the coupon analysis module practiced with the first embodiment;

FIG. 12 is a flowchart indicative of a processing flow of a user analysis module practiced as the first embodiment;

FIG. 13 is a flowchart indicative of a processing flow of a selection prediction module practiced as the first embodiment;

FIG. 14 is a detail flowchart indicative of a processing flow of the selection prediction module practiced as the first embodiment;

FIG. 15 is a flowchart indicative of a processing flow of a list generation module practiced as the first embodiment;

FIG. 16 is a block diagram illustrating a functional configuration of a coupon management server practiced as a second embodiment of the invention;

FIG. 17 is a block diagram illustrating a functional configuration of a user terminal practiced as the second embodiment; and

FIG. 18 is a block diagram illustrating an exemplary hardware configuration of an information processing apparatus capable of realizing the functions of the coupon management servers practiced as the first and second embodiment and the user terminal practiced as the second embodiment.

### DETAILED DESCRIPTION OF THE PREFERRED EMBODIMENTS

This invention will be described in further detail by way of embodiments thereof with reference to the accompanying drawings. It should be noted that, throughout the present specification and the drawings accompanying thereto, the components having substantially the same functional configurations are denoted by the same reference numerals and the description thereof will be skipped for the brevity of description.

### [Flow of Description]

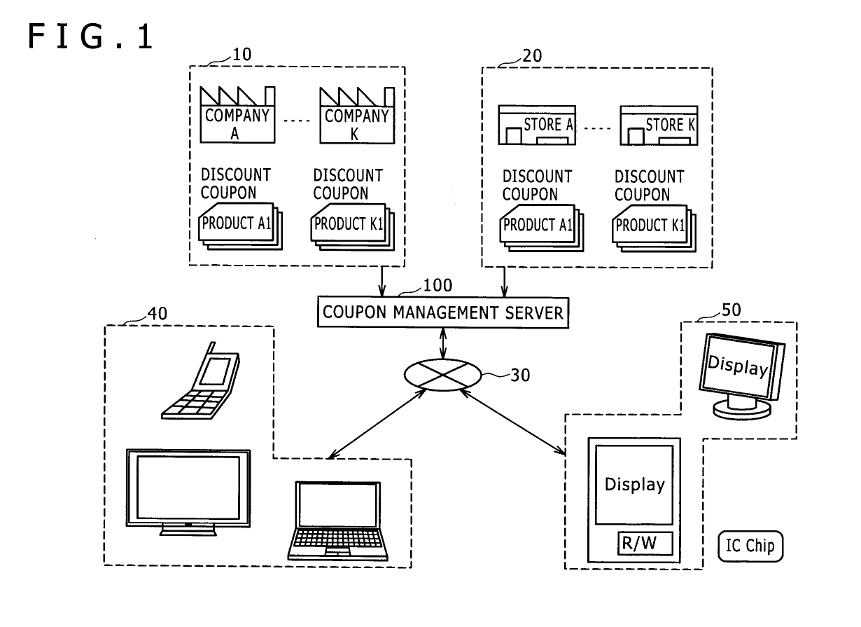

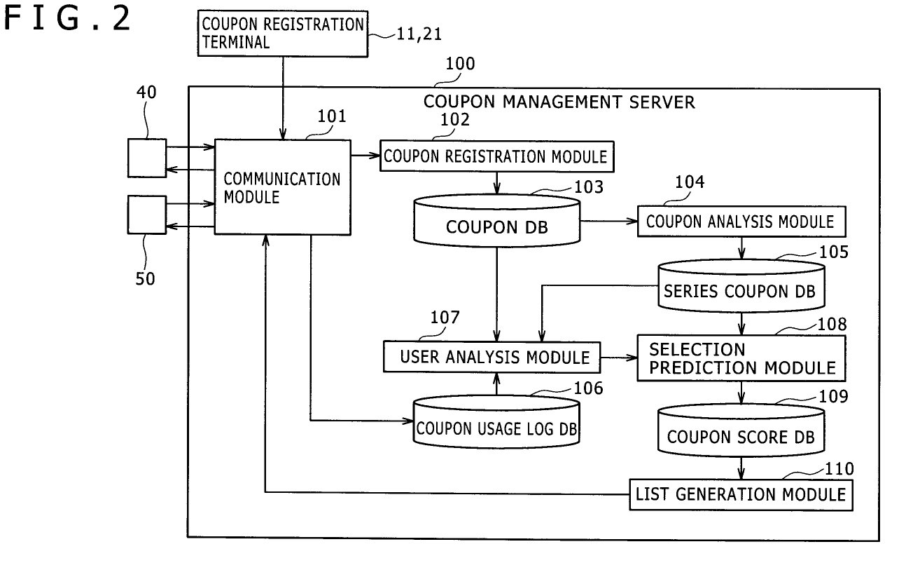

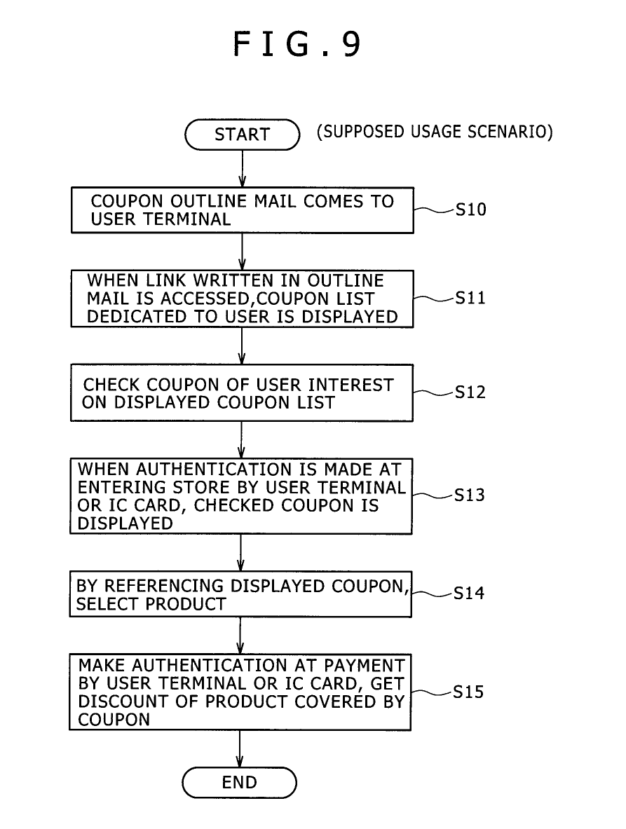

The following briefly describes the flow of description associated with the embodiments of the present invention. First, referring to FIG. 1, a system configuration of a coupon management system associated with the first embodiment will be described. Also, referring to FIG. 9, a scenario of the use of coupons by a user will be briefly described. Next, referring to FIG. 2, a functional configuration of a coupon management server 100 associated with the first embodiment will be described.

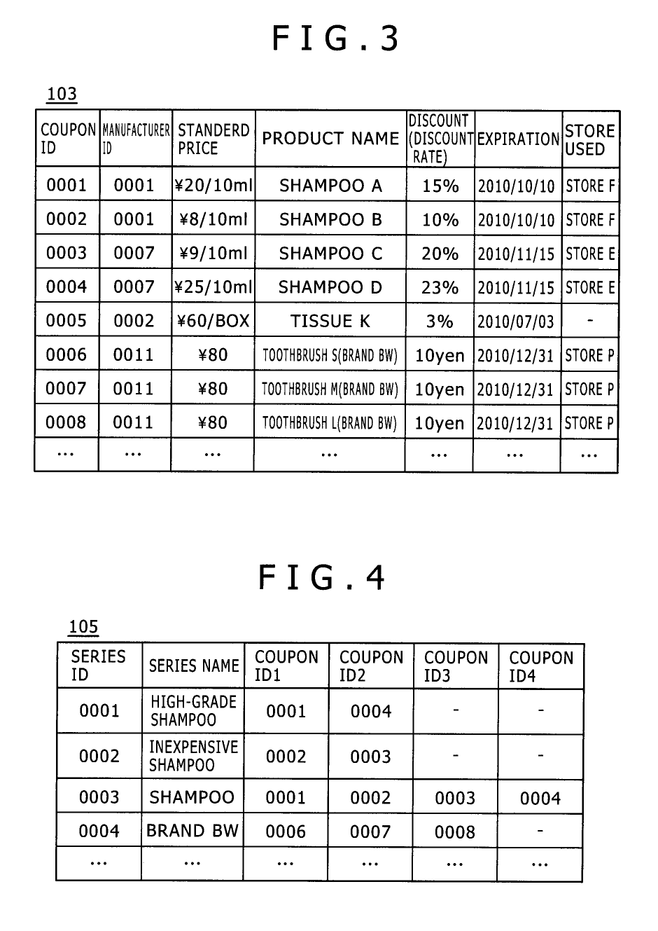

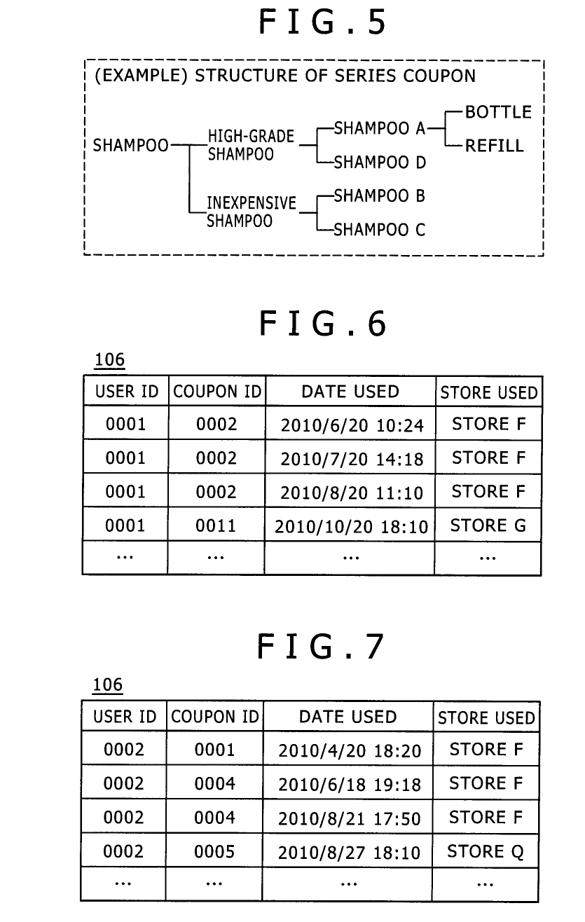

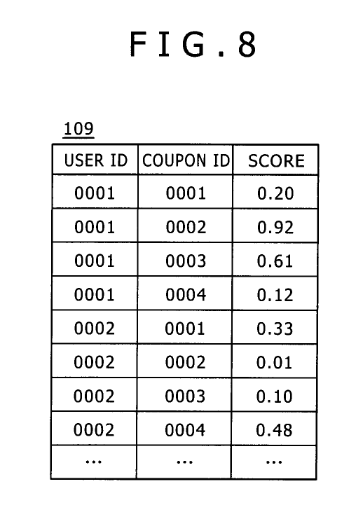

First, a coupon analysis method by a coupon analysis module 104 will be described. In this description, a data structure of the coupon database 103 and a data structure of series coupon database 105 will also be described with reference to FIG. 3, FIG. 4, and FIG. 5. Next, a coupon usage log analysis method to be executed by a user analysis module 107 will be described. In this description, data structures of a coupon usage log database 106 will also be described with reference to FIG. 6 and FIG. 7. Then, a coupon score computation method to be executed by a selection prediction module will be described. In this description, a data structure of a coupon score database 109 is also described with reference to FIG. 8.

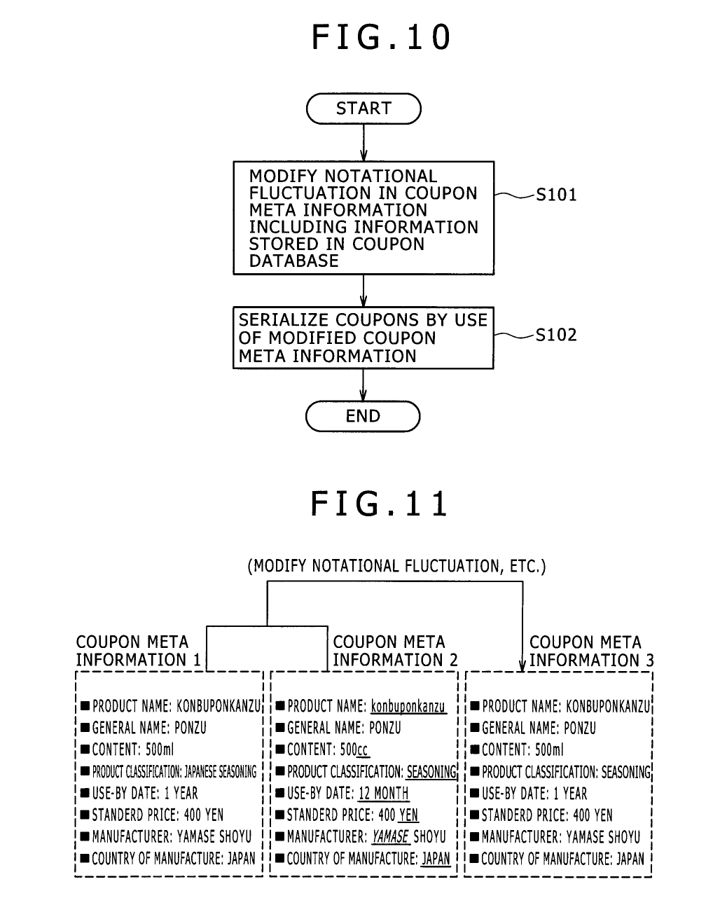

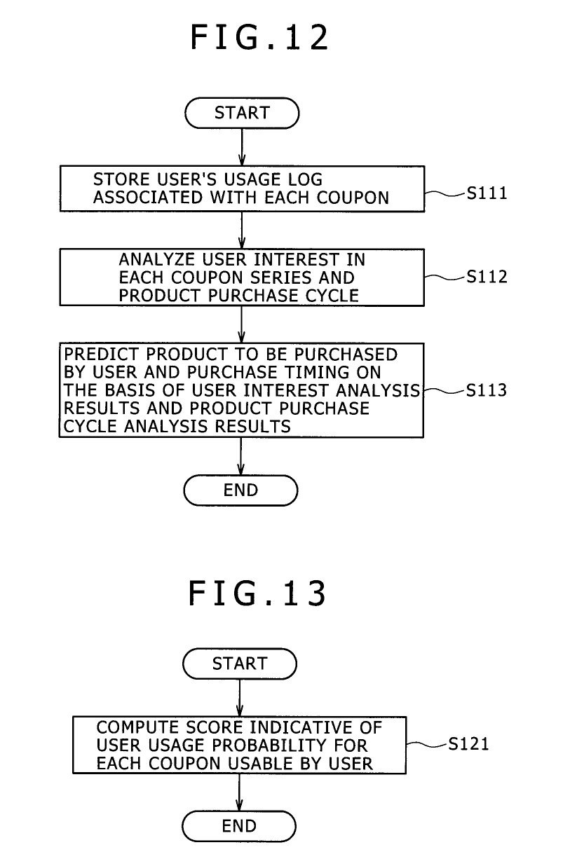

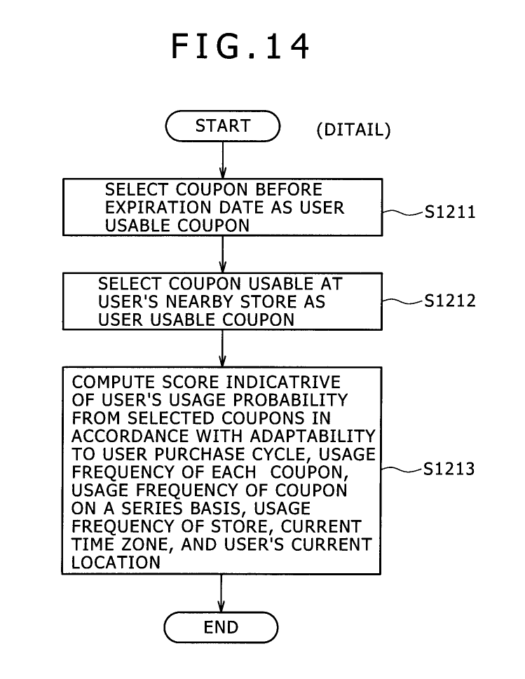

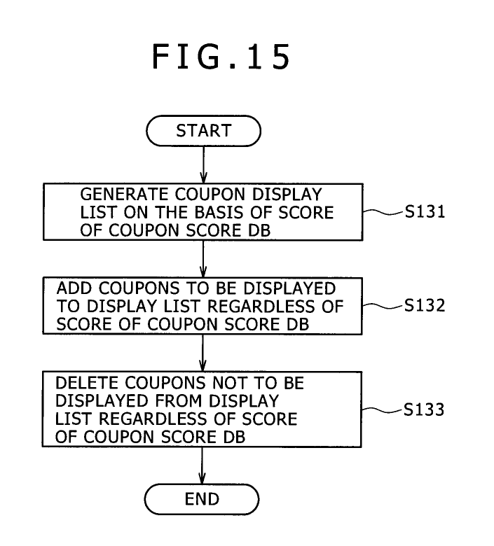

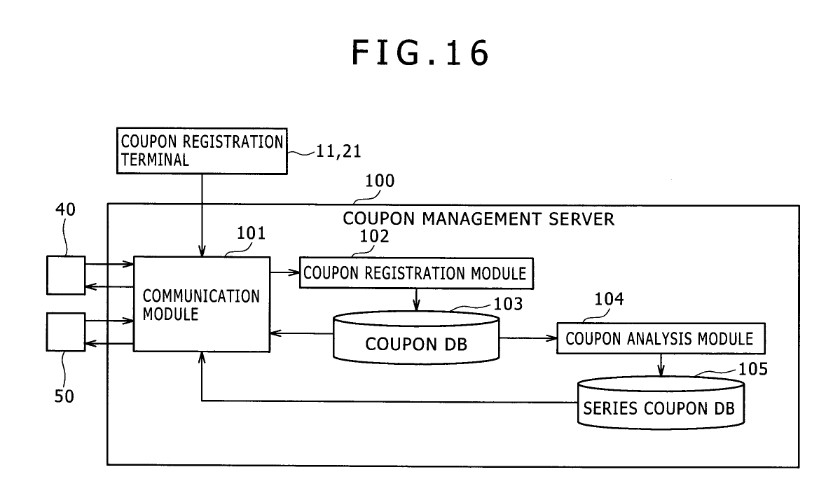

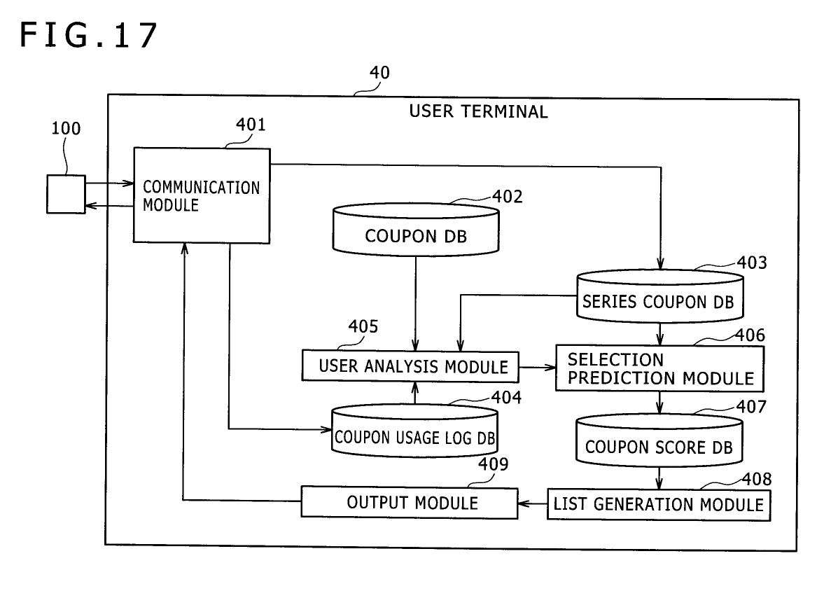

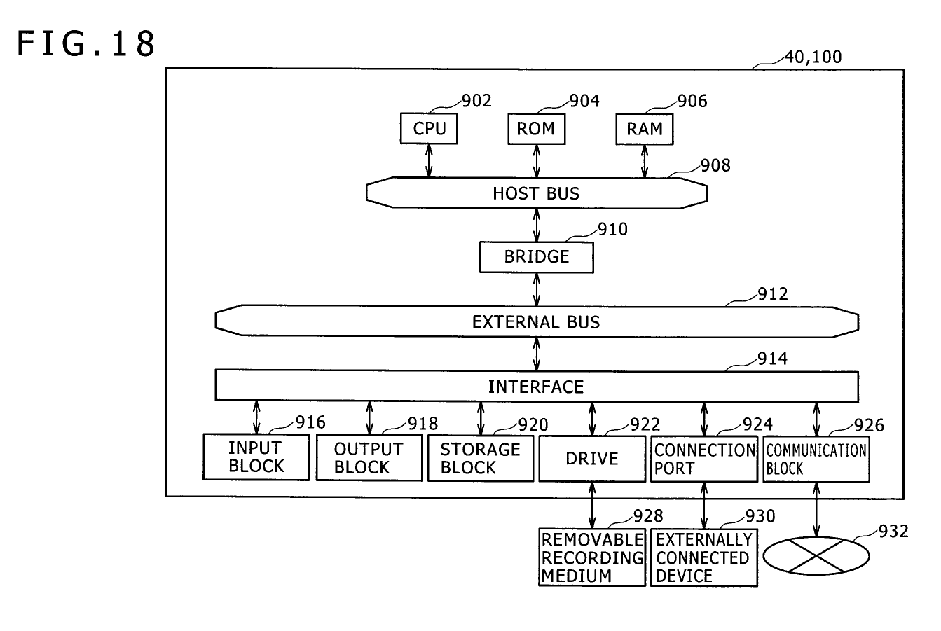

Next, referring to FIG. 10 and FIG. 11, a flow of analysis processing to be executed by the coupon analysis module 104 will be described. Then, referring to FIG. 12, a flow of the analysis processing to be executed by the user analysis module 107 will be described. Next, referring to FIG. 13 and FIG. 14, a flow of the coupon score computation processing to be executed by the selection prediction module 108 will be described. Then, referring to FIG. 15, a flow of the display list generation processing to be executed by a list generation module 110 will be described. Next, referring to FIG. 16 and FIG. 17, a coupon management server 100 and a user terminal 40 practiced as a second embodiment of the invention are described. Next, referring to FIG. 18, an exemplary hardware configuration of an information processing apparatus capable of realizing the functions of the coupon management server 100 and the user terminal 40 will be described.

Lastly, technological concepts of the embodiments of the present invention are summarized and the effects of functions to be obtained from these technological contents will be briefly described.

### (Contents of Description)

### (1) Foreword

(2) First embodiment
(2-1) System configuration
(2-2) Configuration of the coupon management server 100
(2-3) Operation of the coupon management server 100
(3) Second embodiment
(3-1) Configuration of the coupon management server 100
(3-2) Configuration of the user terminal 40
(4) Exemplary hardware configuration

### (5) Summary

### (1) Foreword

Recently, sale promotion methods for promoting purchase by issuing coupons have been gaining popularity in a variety of forms. So far, the main distribution form is the distribution of paper coupons on the street. Recently, however, coupon distributions through networks, such as the Internet, are gaining more popularity. In addition, some large restaurant chains and retail chains have started a coupon distribution form in which coupons are attached to advertisement media provided through networks (hereafter referred to as network advertisements). Further, coupon providers that provide coupons issued by various manufacturers and sellers by use of networks have been appearing, remarkably changing the coupon businesses.

In the rapid expansion of the business of coupons that are provided by use of networks (hereinafter referred to as network coupons) as described above, the number of network coupons issued is increasing hugely. This makes it very difficult for users to find out desired coupons, thereby lowering the usage frequency of network coupons and limiting the usage of coupons only to particular network coupons. In order to overcome these problems, a mechanism for promptly providing the coupons of commercial products to be purchased when a user wants to use coupons is desired. The embodiments of the present invention are intended to satisfy these requirements and associated with a mechanism for enhancing the convenience of coupon selection by each user.

### (2) First Embodiment

The following describes the first embodiment of the present invention.

### (2-1) System Configuration

First, referring to FIG. 1, a system configuration of a coupon management system practiced as the first embodiment will be described. In addition, referring to FIG. 9, a scenario of use of coupons by the user will be briefly described. FIG. 1 is a schematic diagram illustrating a system configuration of a coupon management system practiced as a first embodiment of the invention. FIG. 9 is a flowchart indicative of a user behavior to be expected in using coupons and a coupon usage method.

### (System Configuration)

As shown in FIG. 1, a coupon management system is configured by a manufacturer/producer 10, a seller 20, a network 30, a user terminal 40 (a user terminal group), a store terminal 50 (a store terminal group), and a coupon management server 100, for example. It should be noted that the system configuration shown in FIG. 1 is illustrative only; therefore, the coupon issuers and the configurations of terminals for using coupons can be appropriately changed. It should also be noted that, although FIG. 1 shows a mobile phone, a television receiver (hereafter referred to as a TV), and a personal computer (hereafter referred to as a PC), for example, as the user terminal 40; however, the user terminal 40 is not restricted to these terminal devices. FIG. 1 also shows a monitor display and a store terminal having a reader/writer as the store terminal 50; however, the store terminal 50 is not restricted to these store terminals.

The issuance of coupons is executed by the manufacturer/producer 10 and seller 20. For example, company A manufacturing commercial products issues coupons for discounting the sale prices of commercial products A1 to An. It should be noted here that the coupons to be issued by the manufacturer/producer 10 are issued for commercial products manufactured by the issuer. The coupons to be issued by the manufacturer/producer 10 are intended to promote the commercial products subject to the coupons and can often be used at given stores. On the other hand, the coupons to be issued by the seller 20 are intended to be purchased by stores of the seller 20, so that stores at which the coupons can be used are often restricted to particular stores. Thus, the coupon types and issuance conditions depend on issuers, but the issued coupons are collected by the coupon management server 100 to be managed therein.

The coupon management server 100 provides coupons to the user terminal 40 and the store terminal 50 via a network 30. At the same time, the coupon management server 100 obtains a coupon usage log from the store terminal 50 via the network 30. It should be noted that the coupon management server 100 may be configured to obtain a coupon usage log from the user terminal 40. So far, in providing coupons to the user terminal 40, the coupons to be provided are determined according to the convenience of the manufacturer/producer 10, the seller 20, and the coupon management server 100. However, the coupon management server 100 associated with the first embodiment of the invention provides coupons to individual users on the basis of a providing method customized to the purchase habit of each user. A detail configuration of the coupon management server 100 associated with the first embodiment will be described later.

### (Usage Scenario)

The following describes a coupon usage scenario supposed in the first embodiment with reference to FIG. 9. As shown in FIG. 9, a coupon outline (product information, discount information, and links to coupons, for example) is mailed (hereafter referred to as outline mail) from the coupon management server 100 to the user terminal 40 (S10). When the user accesses a link written in the outline mail, a coupon list dedicated to the accessing user is displayed on the user terminal 40 (S11). If there is any coupon of interest in the coupon list displayed on the user terminal 40, the user checks that coupon (S12).

After checking the coupon, the user goes to a store at which the checked coupon can be used. Then, at entering the store, the user executes the authentication with the store terminal 50 by use of the user terminal 40. It should be noted that, if the information about the checked coupon has been stored in a user's IC card, then the authentication is executed by holding this IC card over the store terminal 50 by the user. When the authentication is established, the coupon checked by the user is displayed on the store terminal 50 (S13).

It should be noted that the user terminal 40 and the store terminal 50 may be configured so as to display the checked coupon on a display section of the user terminal 40. Thus, by allowing the confirmation of the checked coupon at entering the store, the user can reconfirm a commercial product that the user wants to buy by use of the coupon, thereby preventing the coupon from being forgotten or preventing wrong commercial products from being purchased, for example.

Referencing the coupons displayed on the store terminal 50 (or the display section of the user terminal 40), the user selects a commercial product covered by the checked coupon (S14). Next, in making the payment for the purchased product, the user executes the authentication with the store terminal 50 by use of the user terminal 40 (or the IC card). When the authentication is established, the user can get a discount on the commercial product covered by the checked coupon (S15). Thus, the user can get a discount of the price of the commercial product for which the coupon was used in actual shopping.

As described above, the coupon usage procedure is very simple. However, if the time and labor for searching for desired coupons are relatively large, the user withholds the use of coupons because the user feels it is too much of a bother. To prevent such a situation from occurring, the first embodiment of the invention provides a mechanism configured for the user to easily search for the coupons of commercial products to be purchased by use of the function of the coupon management server 100 to be described above.

### (2-2) Configuration of the Coupon Management Server 100

The following describes a functional configuration of the coupon management server 100 practiced as the first embodiment of the invention with reference to FIG. 2. FIG. 2 shows a functional configuration of the coupon management server 100.

As shown in FIG. 2, the coupon management server 100 has a communication module 101, a coupon registration module 102, a coupon database 103, a coupon analysis module 104, and a series coupon database 105. In addition, the coupon management server 100 has a coupon usage log database 106, a user analysis module 107, a selection prediction module 108, a coupon score database 109, and a list generation module 110.

It should be noted that the coupon database 103, the series coupon database 105, the coupon usage log database 106, and the coupon score database 109 are stored in the storage section (not shown) arranged in the coupon management server 100. For this storage section, a RAM 906, a storage block 920, or a removable recording medium 928 in an exemplary hardware configuration shown in FIG. 18 is available, for example. The function of the communication module 101 can be realized by a communication block 926 for example. The functions of the coupon registration module 102, the coupon analysis module 104, the user analysis module 107, the selection prediction module 108, and the list generation module 110 are realized by a CPU 902, for example.

### (Coupon Analysis Method)

As described above, the coupon management server 100 is provided with coupons from the manufacturer/producer 10 and the seller 20 and the provided coupons are registered in the coupon database 103. For example, the manufacturer/producer 10 executes an operation of registering coupons in the coupon database 103 by use of a coupon registration terminal 11. Further, the seller 20 executes an operation of registering coupons in the coupon database 103 by use of a coupon registration terminal 21. When a coupon registration operation is executed through the coupon registration terminals 11, 12, a coupon is entered in the coupon registration module 102 via the communication module 101. When the coupon is entered, the coupon registration module 102 registers the entered coupon into the coupon database 103.

The coupon database 103 has a data structure as shown in FIG. 3 for example. As shown in FIG. 3, each coupon includes information, such as a coupon ID for identifying that coupon, a manufacturer ID indicative of the issuer of that coupon, and the standard price and product name of a commercial product to which that coupon is applied, for example. In addition, each coupon includes information, such as a discount price (or a discount rate) for that standard price, an expiration date (or a valid date) of that coupon, and a place at which that coupon can be used, for example. Obviously, the coupons shown in FIG. 3 are illustrative only; therefore, each coupon may include information other that than described above or partially exclude the information described above.

As shown in FIG. 3, the coupon database 103 stores the information (hereafter referred to as coupon information) included coupons as related with each coupon. As shown in FIG. 2, the coupon information stored in the coupon database 103 is used by the coupon analysis module 104 and the user analysis module 107. The coupon analysis module 104 analyzes the relation between coupons by use of the coupon information stored in the coupon database 103, sorts (or serializes) the associated coupons, and stores the serialized coupons into the series coupon database 105.

The following supplementally describes the relation between coupons with reference to FIG. 3. The coupon database 103 illustratively shown in FIG. 3 stores four types of coupons (coupon IDs=0001, 0002, 0003, and 0004) with shampoos as the coupon subject commercial product. First, analyzing the character strings included in the commercial product names can sort the commercial products having coupon IDs=0001, 0002, 0003, and 0004 in a series called “shampoo” from a common character string. From this analysis result, the coupon analysis module 104 sorts coupon IDs=0001, 0002, 0003, and 0004 into a series called “shampoo.”

Analysis executed with attention paid to standard price indicates that the commercial products having coupon IDs=0001 and 0004 are more expensive than the commercial products having coupon IDs=0002 and 0003. From this analysis result, the coupon analysis module 104 sorts the coupons having coupon IDs=0001 and 0004 into a series called “high-grade shampoo” and the coupons having coupon IDs=0002 and 0003 into a series called “inexpensive shampoo.” Likewise, the coupon analysis module 104 pays attention to the commercial product names having coupon IDs=0006, 0007, and 0008 and sorts these coupons into a series called “Toothbrush.” Further, the coupon analysis module 104 sorts the coupons having coupon IDs=0006, 0007, and 0008 into a series called “BW brand.”

The coupon information sorted by series by the coupon analysis module 104 as described above is stored in the series coupon database 105. As shown in FIG. 4, the series coupon database 105 stores a series name and coupon IDs of the coupons sorted by this series as related with each series ID for identifying a series. It should be noted that the series name may be generated by a combination of a predetermined first keyword and a second keyword extracted from commercial product name or by only the second keyword extracted from a commercial product name.

For example, the coupon analysis module 104 sets the first keyword “high grade” to expensive commercial products and the first keyword “inexpensive” to low-price commercial products. Further, the coupon analysis module 104 extracts character strings (“shampoo,” “toothbrush,” “BW brand,” and “toothbrush (BW brand)” common to the commercial products subject to the coupons sorted into the same series and sets the extracted character strings to the second keyword. FIG. 4 shows series names “high-grade shampoo” and “inexpensive shampoo” using the first and second keywords, for example. FIG. 4 also shows series names “shampoo” and “BW brand” using only the second keyword, for example.

If the coupon information includes a series name or a brand name separate from a commercial product name, the coupon analysis module 104 may use these series name and brand name for sorting. Thus, building series by combining keywords can generate various levels of series. For example, the series associated with the above-mentioned “shampoo” has a hierarchical structure including broad, middle, and narrow concepts as shown in FIG. 5. In the example shown in FIG. 5, the top layer has “shampoo,” the second layer has “high-grade shampoo” and “inexpensive shampoo,” the third layer has “shampoo A” through “shampoo D,” and the fourth layer has “bottle” and “refill.”

The layers shown in FIG. 5 correspond to the details of user's interest and preference. For example, a user who is interested only in low price may be satisfied with shampoo B or shampoo C as long as these shampoos belong to the second layer “inexpensive shampoo” series. On the other hand, a user who is interested not in price but in quality of shampoo A may select “shampoo A” series of the third layer. Further, a user who is interested in environment issues may be interested even in “Refill” series of the fourth layer among the “shampoo A” series. Thus, for “shampoo,” the series desired by users depend on the interest and preference of each user. If coupons are distributed to a user who considers only the series of top layer, that user will have many coupons for commercial products unnecessary for that user, thereby lowering convenience and prompting the feeling of discomfort.

The coupon analysis module 104 associated with the first embodiment builds the series coupon database 105 as shown in FIG. 5 by considering the series corresponding to the details of various interests and preferences of each user. It should be noted that, in the example shown in FIG. 5, series ID and coupon ID are related with each other by the series coupon database 105; however, any other configuration may be used as long as a data structure that provides the correlation between series and coupon.

Now, referring to FIG. 2 again, the coupon management server 100 receives a coupon usage log (or a subject commercial product purchase log) from the store terminal 50 (or the user terminal 40). In other wards, if the user purchases the subject commercial product by use of coupon, then the coupon usage log of the coupon is sent to the coupon management server 100. The coupon usage log thus received is stored in the coupon usage log database 106 via the communication module 101. At this moment, the coupon usage log database 106 stores the coupon usage log including coupon usage date and place for each user as shown in FIG. 6 and FIG. 7. The information (hereafter referred to as log information) indicative of the coupon usage log stored in the coupon usage log database 106 is used by the user analysis module 107.

First, the user analysis module 107 references the coupon usage log database 106 to predict the purchase timing of a same commercial product. For example, the user analysis module 107 analyzes the usage log of a user (hereafter referred to as user 1) having user ID=0001 shown in FIG. 6 and detects that user 1 buys a commercial product subject to coupon ID=0002 once a month. Therefore, the user analysis module 107 references the coupon database 103 to check a commercial product subject to coupon ID=0002 (“shampoo B” in the example shown in FIG. 3). Further, the user analysis module 107 references the series coupon database 105 to check the series (“inexpensive shampoo” in the example shown in FIG. 4) in which coupon ID=0002 is sorted.

From these analysis results, the user analysis module 107 determines that user 1 prefers “inexpensive shampoo” and buys “inexpensive shampoo” about every month. Further, the user analysis module 107 references the coupon usage log database 106 to check the date (“2010/8/20 11:10” in the example shown in FIG. 6) on which user 1 last bought “inexpensive shampoo” and a place of purchase (a place at which coupon ID=0002 was bought; “store F” in the example shown in FIG. 6). Then, the user analysis module 107 relates series=“inexpensive shampoo,” purchase cycle=“about one month,” last purchase date=“2010/8/20,” and purchase place=“store F” with user 1 and sends this information to the selection prediction module 108.

Likewise, the user analysis module 107 analyzes the usage log of a user (hereafter referred to as user 2) having user ID=0002 shown in FIG. 7 and detects that user 2 buys commercial products subject to coupon IDs=0001 and 0004. Therefore, the user analysis module 107 references the coupon database 103 to check commercial products subject to coupon IDs=0001 and 0004 (“shampoo A” and “shampoo D” in the example shown in FIG. 3). Further, the user analysis module 107 references the series coupon database 105 to check the series (“high-grade shampoo” in the example shown in FIG. 4) in which coupon IDs=0001 and 0004 are sorted.

From these analysis results, the user analysis module 107 determines that user 2 prefers “high-grade shampoo.” In response to this decision, the user analysis module 107 checks usage date (the coupon usage log database 106) of coupon IDs=0001 and 0004 corresponding to “high-grade shampoo” to determine that user 2 buys “high-grade shampoo” about every other month. Further, the user analysis module 107 references the coupon usage log database 106 to check the date (“2010/8/21 17:50” in the example shown in FIG. 7) on which user 2 last bought “high-grade shampoo” and a place of purchase (a place at which coupon ID=0004 was bought; “store F” in the example shown in FIG. 7). Then, the user analysis module 107 relates series=“high-grade shampoo,” purchase cycle=“about two month,” last purchase date=“2010/8/21,” and purchase place=“store F” with user 2 and send this information to the selection prediction module 108.

It should be noted that the user analysis module 107 may detect areas in which users buy commercial products from the coupon usage places stored in the coupon usage log database 106. For example, this allows the user analysis module 107 to detect a place at which coupons for daily commodities as subject commercial products are used to identify a predetermined area including a result of this detection, thereby identifying the livelihood sphere of each user. When the livelihood sphere of each user has been identified, the coupons that can be used only at certain stores outside the livelihood sphere can be controlled not to be presented to the user of this livelihood sphere. To be more specific, the coupons for the stores not shopped by the user are not presented to the user, thereby enhancing coupon searchability and reducing the chances of discomforting the user. Consequently, if the livelihood sphere of each user has been detected by the user analysis module 107, a result of this detection is also entered in the selection prediction module 108.

The selection prediction module 108 provides a section for computing a score (hereafter referred to as a coupon score) indicative of a probability of the use of a coupon by a given user. It should be noted that the selection prediction module 108 may compute a coupon score of each user for each series stored in the series coupon database 105. However, the following describes an example in which the selection prediction module 108 computes a coupon score of each user for each coupon. As described above, the selection prediction module 108 has such information as series, purchase cycle, last purchase date, purchase place, and livelihood sphere (hereafter referred to as a user analysis result) supplied from the user analysis module 107. Therefore, the selection prediction module 108 computes a coupon score on the basis of a user analysis result of each user and stores the computed result into the coupon score database 109.

A coupon score is given for each usage timing. Therefore, as the purchase timing of a subject commercial product comes closer, the coupon score of the coupon corresponding to that subject commercial product is set higher. Further, because a coupon score is a score indicative of a probability of the usage of a coupon by the user, the score of a coupon of a commercial product having a low probability of user's buying the corresponding commercial product is set lower. For example, for the coupon of commercial product “shampoo B” that is “inexpensive shampoo,” the coupon score of user 2 who prefers “high-grade shampoo” is set low. For a coupon that can be used only outside the user's livelihood sphere, the coupon score of that user is set low. Likewise, for a coupon that can be used only at stores not frequently used by the user, the coupon score of that user is set low.

The coupon score computation results to be stored in the coupon score database 109 are as shown in FIG. 8 (an example of timing 2010/9/19). The user (user 1) having user ID=0001 prefers “inexpensive shampoo.” The purchase cycle of “inexpensive shampoo” is about one month. The date on which user 1 bought “inexpensive shampoo” is “2010/8/20.” User 1 is high in frequency of buying commercial product “shampoo B” among “inexpensive shampoos.” User 1 is high in frequency in buying “inexpensive shampoo” at “store F.”

In this case, the selection prediction module 108 sets low the coupon score of the coupons (coupon IDs=0001, 0004) for commercial products “shampoo A” and “shampoo D” that belong to “high-grade shampoo.” On the other hand, the selection prediction module 108 sets high the coupon score of the coupons (coupon IDs=0002, 0003) for commercial products “shampoo B” and “shampoo C” that belong to “inexpensive shampoo.” Especially, the selection prediction module 108 sets high the coupon score of the coupon (coupon ID=0002) for commercial product “shampoo B” that is high in purchase frequency, the coupon being used at “store F.” Also, the selection prediction module 108 sets high the coupon score of “shampoo” because purchase timing “2010/9/20” predicted from the last purchase date and the purchase cycle is nearing.

On the other hand, the user (user 2) having user ID=0002 prefers “high-grade shampoo.” The purchase frequency of “High-grade shampoo” is about two months. Further, the date on which user 2 last bought “high-grade shampoo” is “2010/8/21.” Of “high-grade shampoos,” the frequency for user 2 to buy “shampoo D” is comparatively high. Also, user 2 buys “high-grade shampoo” at “store F.”

In this case, the selection prediction module 108 sets low the coupon score of the coupons (coupon IDs=0002, 0003) for commercial products “shampoo B” and “shampoo C” that belong to “inexpensive shampoo.” On the other hand, the selection prediction module 108 sets high the coupon score of the coupons (coupon IDs=0001, 0004) for the commercial products “shampoo A” and “shampoo D” that belong to “high-grade shampoo.” Especially, the selection prediction module 108 sets high the coupon score of the coupon (coupon ID=0004) for the commercial product “shampoo D” high in purchase frequency, the coupon being used at “store F.” Also, the selection prediction module 108 sets low the coupon score of “shampoo” because it takes as long as one month to reach purchase timing “2010/10/21” predicted from the last purchase date and the purchase cycle.

As described above, the selection prediction module 108 computes the coupon score of each user for each coupon and stores the computed coupon score into the coupon score database 109. The coupon score stored in the coupon score database 109 is used by the list generation module 110. The list generation module 110 references the coupon score database 109 to generate a display list for presenting coupons having a high coupon score to the user. This display list mainly includes the coupons having a high coupon score in the form of a list. It should be noted that this display list may also include coupons sorted into the same series of coupons having a high coupon score or those coupons which the coupon issuer or the manager of the coupon management server 100 especially wants to include in the list. It should also be noted that coupons of a low coupon score may be included in this display list.

The display list generated by the list generation module 110 is transmitted to the user terminal 40 via the communication module 101. Then, the user checks the display list shown on the display section of the user terminal 40 for desired coupons. Thus, the display list generated by the coupon management server 100 associated with the first embodiment reflects the preference and interest of each user and includes the coupons selected by considering also purchase timing. Therefore, commercial products that the user wants to buy are preferentially displayed on the display list every time the user wants to buy each commercial product, so that the user is able to efficiently find out desired coupons. As a result, the time and labor for using coupons are reduced, thereby significantly enhancing user convenience.

### (Prediction of Purchase Timing)

For the brevity of description, the following describes a method of predicting purchase timings simply from the cycle of usage dates without considering the content amount and number of commercial products bought by each user. It should be noted that this method is able to correctly detect a purchase cycle in which the user buys the same amount of commercial products every time. However, it is difficult for this method to predict a timing of purchase of commercial products by the user who buys these products in different amounts every time. Therefore, the following additionally describes a more realistic and effective prediction method for predicting purchase timings in accordance with the amounts of commercial products bought by the user.

The coupon information includes amounts as the information about subject commercial products. For example, the coupon information of “shampoo B” includes the information about content amounts. The coupon of “tissue paper K” includes the information about an amount (the number of sheets in a box). Therefore, when a given coupon is used by the user, the amount of commercial products bought by the user for each coupon can be understood from the coupon information of the coupon used by the user. Further, recording the number of used coupons allows the understanding of all amounts of commercial products bought by the user at a certain point of time. These pieces of information are stored in the coupon usage log database 106.

Next, the user analysis module 107 analyzes the information indicative of the amounts of commercial products (hereafter referred to as amount information) along with the usage date and the coupon IDs stored in the coupon usage log database 106 and outputs the purchase cycle of each commercial product. To be more specific, the user analysis module 107 computes the consumption period per unit amount to obtain a period during which the amount bought by the user is consumed. Then, from the usage date on which a coupon was used the last time, the user analysis module 107 computes the date that passed by the period computed above, providing the next purchase timing that is around the computed date.

The computations described above allow the correct prediction of a timing with which a product will be bought next not only from the cycle of coupon usage date but also from the amount of the commercial product bought the last time. Further, on the basis of the purchase timing thus predicted, the coupon score is computed. Application of the method described so far prevents the coupons of the commercial product still in stock of the user from being preferentially displayed on the display list, thereby enabling the user to easily search for necessary coupons.

In the above, the functional configuration of the coupon management server 100 associated with the first embodiment has been described.

### (2-3) Operation of the Coupon Management Server 100

The following describes operations of the coupon management server 100 associated with the first embodiment and a coupon management method associated with the first embodiment with reference to FIG. 10 through FIG. 15. Especially, the following describes the operations of the coupon analysis module 104, the user analysis module 107, the selection prediction module 108, and the list generation module 110.

### (Operation of the Coupon Analysis Module 104)

First, an operation of the coupon analysis module 104 will be described with reference to FIG. 10 and FIG. 11. FIG. 10 shows a flowchart indicative of an operation of the coupon analysis module 104. FIG. 11 shows the processing of modifying notational fluctuations. It should be noted that a notational fluctuation denotes that the information of the same meaning looks different to the computer due to differences in unit, font, or language.

First, referring to FIG. 10, the coupon analysis module 104 modifies a notational fluctuation in coupon meta information, such as the information stored in the coupon database 103 (S101). The coupon meta information as referred to herein denotes various kinds of information assigned to each coupon. For example, the information, such as standard price, commercial product name, discount amount (discount rate), expiration date, and coupon usage place, stored in the coupon database 103 are included in the coupon meta information. Further, as shown in FIG. 11, various kinds of information associated with commercial products subject to coupons are included in the coupon meta information.

For example, the coupon meta information includes commercial product name, general name, content amount, commercial product classification, use-by date, standard price, manufacturer name, and manufacturing country name as shown in FIG. 11. It should be noted that a general name denotes a popular name used for the commercial products similar to a commercial product concerned. This general name is assigned by the manufacturer/producer 10 for example. Therefore, some commercial products of the same type may have partially different common names.

For the expression of a content amount, a unit (cc, ml, dl, or g, for example) may be used to express the amount. Likewise, the expression of use-by date may use a unit (year, month, week, and/or day, for example). Further, items including character strings, such as commercial product name, general name, commercial product classification, manufacturer name, and manufacturing country name, may be expressed by different languages (Japanese, English, and so on) and different fonts (uppercase or lowercase for example).

For these reasons, the coupon analysis module 104 modifies a notational fluctuation included the coupon meta information. As shown in FIG. 11, the case where two or more types (coupon meta information 1 and coupon meta information 2) of coupon meta information corresponding to a same commercial product exist is considered. The commercial product name of coupon meta information 1 is written in uppercase. On the other hand, the commercial product name of coupon meta information 2 is written in lowercase. These commercial product names look the same to the human eyes but may be interpreted by the computer to be different from each other. To overcome this problem, the coupon analysis module 104 integrates the notations of a commercial product name into a notation composed of uppercase letters, for example. Namely, if coupon meta information 2 is provided, the coupon analysis module 104 modifies the lower-case notation included in a commercial product concerned to an upper-case notation.

Likewise, in the example shown in FIG. 11, the coupon analysis module 104 also modifies (or cuts modifying expression) the unit of content amount from “cc” to “ml” and the commercial product classification from “Japanese seasoning” to more general “seasoning.” In addition, in the example shown in FIG. 11, the coupon analysis module 104 modifies use-by date from “month” to “year” and the unit of standard price from English notation “yen” to Japanese notation “yen.” Further, in the example shown in FIG. 11, the coupon analysis module 104 modifies the manufacturer name from italic notation to normal notation and the manufacturing country name from English notation to Japanese notation. As a result of these modifications, the coupon analysis module 104 modifies the notational fluctuation of coupon meta information to obtain coupon meta information 3.

Obviously, the method of modifying notational fluctuations is not limited to the above-mentioned method; any other appropriate method is available. However, it should be noted that, whichever method is used, how notational fluctuations are to be modified must be determined in advance. In the case of a modification method for modifying notational fluctuations associated with items having a high degree of freedom of modification, such as commercial product classification, (1) the user creates a dictionary for modification in advance and modifies notational fluctuations on the basis of this dictionary or (2) an algorithm for modification created in advance by machine learning is used to modify notational fluctuations. Obviously, methods (1) and (2) above may be combined. It should be noted that, in assigning coupon meta information to each coupon, it is desired to prevent notational fluctuations from taking place.

Referring to FIG. 10 again, having executed the notational fluctuation modification as shown above, the coupon analysis module 104 serializes coupons by use of the modified coupon meta information (S102). As described above, the coupon analysis module 104 references the coupon database 103 to serialize coupons on the basis of commercial product names and price zones. Especially, the coupon analysis module 104 serializes coupons by considering the details of preference of each user. Namely, the coupon analysis module 104 integrates groups of commercial products that each user may recognize to be substantially the same product in user's selecting coupons into one series.

For example, for users who prefer low-price commercial products, it is highly possible for “shampoo B” and “shampoo C” shown in FIG. 3 to be recognized as being substantially the same commercial product. On the other hand, users who prefer “BW brand,” it is highly possible for “toothbrush S,” “toothbrush M,” and “toothbrush L” shown in FIG. 3 to be recognized as being substantially the same commercial product. For uses who are interested in the manufacturer having manufacturer ID=0007, it is highly possible for “shampoo C and “shampoo D” shown in FIG. 3 to be recognized as being substantially the same commercial product. Further, for users who are interested in discount rate, it is highly possible for “shampoo C” and “shampoo D” shown in FIG. 3 to be recognized as being substantially the same commercial product.

The coupon analysis module 104 serializes the coupons for the above-mentioned commercial products that are highly possible to be recognized as being substantially the same commercial product. It should be noted that the commercial products that are highly possible to be recognized as being substantially the same product may be sorted by extracting a character string common to commercial product names, assigning the commercial products including the common character string to one classification item, and sorting, from among the commercial products of the same type, the commercial products of a high-price zone and the commercial products of a low-price zone into separate classification items on the basis of a standard price. Further, from among the commercial products of the same type, the commercial products having the same manufacturer ID may be sorted into one classification item or the commercial products high in discount rate and low in discount rate may be sorted into different classification items. Then, the coupon analysis module 104 can serialize the coupons corresponding to the commercial products thus sorted, thereby serializing the commercial products that are highly possible for the user to recognize as being substantially the same commercial product.

### (Operation of the User Analysis Module 107)

The following describes an operation of the user analysis module 107 with reference to FIG. 12. FIG. 12 is a flowchart indicative of an operation of the user analysis module 107.

As shown in FIG. 12, first, when the user uses a coupon, a coupon usage log is stored in the coupon usage log database 106 for each user (S111). Next, the user analysis module 107 uses the usage log for each user stored in the coupon usage log database 106 to analyze user's preference, interest, and purchase habit (S112).

For example, if the user buys only “inexpensive shampoo,” then many usage logs of the coupons corresponding to “inexpensive shampoo” are stored in the coupon usage log database 106. Therefore, the user analysis module 107 determines that this user is highly interested in the “inexpensive shampoo” series. If the user buys “inexpensive shampoo” every month, then the usage logs of the coupons corresponding to “inexpensive shampoo” are stored in the coupon usage log database 106 about every month. Therefore, the user analysis module 107 determines that the purchase cycle in which this user buys “inexpensive shampoo” is about one month.

As described above, the user analysis module 107 detects the degree of interest and the purchase cycle for each series (or each coupon) stored in the series coupon database 105 for each user. Next, on the basis of an analysis result of the degree of interest and an analysis result of the commercial product purchase cycle, the user analysis module 107 predicts commercial products to be purchased by the user and the purchase timing of these products (S113). For example, if the user who buys “high-grade shampoo” every two months uses the coupon of “high-grade shampoo” on 2009/8/20, then the user analysis module 107 predicts that this user will buy “high-grade shampoo” on 2009/10/20. Thus, the information about the a commercial product to be purchased (a specific commercial product name or series) and the purchase cycle predicted by the user analysis module 107 is supplied to the selection prediction module 108.

### (Operation of the Selection Prediction Module 108)

The following describes an operation of the selection prediction module 108 with reference to FIG. 13 and FIG. 14. FIG. 13 is a flowchart indicative of an operation of the selection prediction module 108. FIG. 14 is a flowchart indicative of the operation of the selection prediction module 108 in more detail.

As shown in FIG. 13, the selection prediction module 108 computes, for each of coupons usable by the user, a score (a coupon score) indicative of a probability of user's use of coupon (S121). As shown in FIG. 14, the selection prediction module 108 first references the series coupon database 105 to select a coupon before the expiration date to select as a coupon available for the user (S1211). Next, the selection prediction module 108 selects a coupon usable at stores near user's home as a coupon available for the user (S1212). It should be noted that the processing of step S1212 is executed if the livelihood sphere and so on of the user have been predicted by the user analysis module 107.

Next, for the selected coupon, the selection prediction module 108 computes a coupon score in accordance with the adaptability to purchase cycle, the usage frequency of each coupon, the usage frequency of each coupon on a series basis, the usage frequency of store, the current time zone, and current location of the user (S1213). For example, if a commercial product subject to a certain coupon has reached the purchase timing predicted from the last purchase date and the purchase cycle, the selection prediction module 108 sets high the coupon score of that coupon. If the usage frequency of a certain coupon is high, the selection prediction module 108 also sets comparatively high the coupon score of that coupon.

If the usage frequency of a coupon included in a certain series is high, then the selection prediction module 108 sets comparatively high the coupon score of the coupon included in that series (or the score of that series). Further, if the usage frequency of a certain store is high, then the selection prediction module 108 sets comparatively high the coupon score of a coupon usable at that store. Then, if the usage time zone of a coupon included in a certain series is determined, then the selection prediction module 108 sets comparatively high the coupon score of the coupon included in that series (or the score of that series). If the current location of the user can be known by use of GPS (Global Positioning System) for example, then the selection prediction module 108 sets comparatively high the coupon score of the coupon usable at a store near the current location of the user.

The coupon score set by the selection prediction module 108 as described above is stored in the coupon score database 109. Then, the coupon score of each coupon (or the score of the series) stored in the coupon score database 109 is used by the list generation module 110. It should be noted that term “the score of series” used in the above description means the score to be set for each user on a series basis. In many cases, in providing a certain coupon to a user, a coupon belonging to the same series of that coupon is also provided at the same time. Hence, a score may be set on a series basis to determine a coupon to be presented to the user with reference to the score on a series basis. It should be noted here that, in the first embodiment, the score of series may or may not be used.

### (Operation of the List Generation Module 110)

The following describes an operation of the list generation module 110 with reference to FIG. 15. FIG. 15 is a flowchart indicative of an operation of the list generation module 110.

As shown in FIG. 15, the list generation module 110 generates a display list of coupons on the basis of the coupon score stored in the coupon score database 109 (S131). At this moment, the list generation module 110 selects the predetermined number of coupons in the descending order of coupon scores and adds the coupon information of the selected coupons to the display list. In addition, the list generation module 110 generates a display list for each user.

Next, regardless of the coupon score stored in the coupon score database 109, the list generation module 110 adds the coupons to be presented to the user to the display list (S132). Then, regardless of the coupon score stored in the coupon score database 109, the list generation module 110 deletes the coupons not to be presented to the user from the display list (S133). For example, in the case where the manufacturer/producer 10 or seller 20 issued coupons of new commercial products to be sale-promoted in a specific period, the list generation module 110 adds the coupons of new commercial products not yet set with a coupon score to the display list.

The display list generated by the list generation module 110 as described above is transmitted to the user terminal 40 via the communication module 101. It should be noted that this display list may be transmitted to the store terminal 50 via the communication module 101.

The operations of the coupon management server 100 and the coupon management method associated with the first embodiment have been described.

As described above, applying the coupon management method practiced with the first embodiment of the invention allows each user to easily obtain the coupons of commercial products that the user plans to buy at a certain point of time. As a result, the usage of coupons is promoted, chances increase in which each user is able to buy commercial products at low prices, and the manufacturer/producer 10 and the seller 20 are able to obtain high sale promotion effects.

### (3) Second Embodiment

The following describes the second embodiment of the present invention. In the above-mentioned first embodiment, the analysis of coupons and the analysis of users are all managed by the coupon management server 100. However, as the number of users increases, the load of the analysis processing to be executed by the coupon management server 100 increases. Especially, the computation load required by the user analysis increases as the number of users increases. Therefore, the second embodiment proposes a system configuration in which the processing associated with the user analysis is executed by a user terminal 40 in order to suppress the increase in the processing loads. In the proposed system configuration, each user terminal 40 analyzes only the usage log of itself, so that any increase in the number of users will not increase the computation load in each user terminal 40. Therefore, the system configuration associated with the second embodiment has a higher expandability than that of the system configuration of the first embodiment.

### (3-1) Configuration of the Coupon Management Server 100

First, a configuration of the coupon management server 100 associated with the second embodiment will be described with reference to FIG. 16. It should be noted that the components having substantially the same functions as those of the coupon management server 100 associated with the above-mentioned first embodiment are denoted by the same reference numerals and the detail description of these components of the coupon management server 100 of the second embodiment will be skipped. FIG. 16 shows a block diagram illustrating the configuration of the coupon management server 100 associated with the second embodiment.

As shown in FIG. 16, the coupon management server 100 has a communication module 101, a coupon registration module 102, a coupon database 103, a coupon analysis module 104, and a series coupon database 105. As compared with the coupon management server 100 associated with the first embodiment shown in FIG. 2, the coupon management server 100 shown in FIG. 6 lacks the coupon usage log database 106, the user analysis module 107, the selection prediction module 108, the coupon score database 109, and the list generation module 110. Namely, the coupon management server 100 associated with the second embodiment is an apparatus mainly for serializing coupons and providing the information about a resultant series.

It should be noted that an analysis method and a coupon serialization method that are executed by the coupon analysis module 104 are substantially the same as those of the first embodiment. A difference from the first embodiment lies in that the information about each series stored in the series coupon database 105 is transmitted to the user terminal 40 via the communication module 101. Therefore the function of the communication module 101 is different from that of the coupon management server 100 associated with the above-mentioned first embodiment. When coupon information is analyzed by the coupon analysis module 104 and serialized coupon information is stored in the series coupon database 105, the communication module 101 transmits the information associated with each series to the user terminal 40. It should be noted that the communication module 101 may transmit the information associated with each series to the store terminal 50.

Thus the configuration of the coupon management server 100 has been described.

### (3-2) Configuration of the User Terminal 40

The following describes a configuration of the user terminal 40 associated with the second embodiment with reference to FIG. 17. FIG. 17 is a block diagram illustrating the configuration of the user terminal 40 associated with the second embodiment.

As shown in FIG. 17, the user terminal 40 has a communication module 401, a coupon database 402, a series coupon database 403, a coupon usage log database 404, a user analysis module 405, a selection prediction module 406, a coupon score database 407, a list generation module 408, and an output module 409.

It should be noted that the function of the user analysis module 405 is substantially the same as that of the user analysis module 107 associated with the first embodiment. The function of the selection prediction module 406 is substantially the same as that of the selection prediction module 108 associated with the first embodiment. The function of the list generation module 408 is substantially the same as that of the list generation module 110 associated with the first embodiment. Therefore, the detail descriptions of the user analysis module 405, the selection prediction module 406, and the list generation module 408 will be skipped.

First, the communication module 401 obtains coupon information (the information about coupons stored in the above-mentioned coupon database 103) from the coupon management server 100. Next, the coupon information obtained by the communication module 401 is stored in the coupon database 402. Further, the communication module 401 obtains information associated with series (the series stored in the above-mentioned series coupon database 105 and coupons corresponding to each series). Then, the information associated with the series obtained by the communication module 401 is stored in the series coupon database 403.

When the user uses a coupon, a coupon usage log is stored in the coupon usage log database 404 via the communication module 401. It should be noted that the usage log associated with all users is stored in the coupon usage log database 106 associated with the above-mentioned first embodiment, but only the coupon usage log associated with the user concerned (the user of the user terminal 40) is stored in the coupon usage log database 404. When the information is stored in the coupon database 402, the series coupon database 403, and the coupon usage log database 404, the user analysis module 405 analyzes user preference, interest, and purchase habit.

Further, on the basis of an analysis result obtained from the user analysis module 405, the selection prediction module 406 computes a coupon score of each coupon and stores the computed coupon score of each coupon into the coupon score database 407. When the coupon score is stored in the coupon score database 407, the list generation module 408 generates a display list of coupons on the basis of the coupon score stored in the coupon score database 407. Next, the display list generated by the list generation module 408 is outputted by the output module 409. The output module 409 is a display section, such as a monitor display for example. It should be noted that the display list generated by the list generation module 408 may be transmitted to the store terminal 50 via the communication module 401 and the coupon management server 100.

Thus, the configuration of the user terminal 40 has been described.

As described above, applying the system configuration associated with the second embodiment allows the dispersing of the computation load required for coupon usage log analysis to two or more user terminal 40, thereby mitigating the computation load. In addition, applying the system configuration associated with the second embodiment makes it difficult for the user personal information, such as user preference and interest, from being leaked outside the user terminal 40, thereby enhancing information security. As a result, the management load of the coupon management server 100 is lowered.

### (4) Exemplary Hardware Configuration

The functions of the component elements of the coupon management server 100 and the user terminal 40 mentioned above can be realized by use of a hardware configuration of an information processing apparatus shown in FIG. 18. To be more specific, the functions of these component elements are realized by use of computer programs and controlling the computer hardware shown in FIG. 18. It should be noted that this hardware may take any forms; for example, this hardware includes a personal computer, a portable information terminal such as mobile phone, PHS, or PDA, a game machine, and various household information electronics. It should be noted that PHS is short for Personal Handy-phone System and PDA is short for Personal Digital Assistant.

As shown in FIG. 18, this hardware mainly has a CPU 902, a ROM 904, a RAM 906, a host bus 908, and a bridge 910. Further, this hardware has an external bus 912, an interface 914, and input block 916, an output block 918, a storage block 920, a drive 922, a connection port 924, and a communication block 926. It should be noted that CPU is short for Central Processing Unit, ROM is short for Read Only Memory, and RAM is short for Random Access Memory.

The CPU 902 functions as a computation processing apparatus or a control apparatus, thereby controlling all or part of the operations of the component elements as instructed by various programs stored in the ROM 904, the RAM 906, the storage block 920, or a removable recording medium 928. The ROM 904 provides a section for storing programs read by the CPU 902 and data to be used for computation processing. The RAM 906 temporarily or permanently stores programs to be read by the CPU 902 and various parameters that change from time to time when these programs are executed, for example.

These component elements are interconnected by the host bus 908 that provides high-speed data transmission. On the other hand, the host bus 908 is connected, via the bridge 910, to the external bus 912 that provides low-speed data transmission. The input block 916 is a mouse, a keyboard, a touch panel, buttons, switches, and levers, for example. In addition, the input block 916 may have a remote controller that is capable of transmitting control signals by use of infrared ray or other electromagnetic waves.

The output block 918 is based on a display apparatus, such as CRT, LCD, PDP, or ELD, an audio output apparatus, such as loudspeaker or headphone, a printer, a mobile phone, and/or a facsimile that provide obtained information to the user in visual and audible manners. It should be noted that CRT is short for Cathode Ray Tube, LCD is short for Liquid Crystal Display, PDP is short for Plasma Display Panel, and ELD is short for Electro-Luminescence Display.

The storage block 920 is an apparatus for storing various kinds of data. The storage block 920 is a magnetic storage device, such as an HDD, a semiconductor storage device, an optical storage device, or a magneto-optical storage device, for example. It should be noted that HDD is short for Hard Disk Drive.

The drive 922 is an apparatus for reading information from the removable storage medium 928, such as a magnetic disk, an optical disk, a magneto-optical disk, or a semiconductor memory, for example, or writing information to the removable recording medium 928. The removable recording medium 928 includes a DVD medium, a Blu-ray medium, an HD DVD medium, and various semiconductor storage media, for example. Obviously, the removable recording medium 928 may be an IC card having a non-contact IC chip or an electronic device. It should be noted that IC is short for Integrated Circuit.

The connection port 924 is a port for connecting an externally connected device 930, such as a USB port, an IEEE1394 port, a SCSI port, an RS-232C port or an optical audio terminal, for example. The externally connected device 930 is a printer, a portable music player, a digital camera, a digital video camera, or an IC recorder, for example. It should be noted that USB is short for Universal Serial Bus and SCSI is short for Small Computer System Interface.

The communication block 926 is a communication device for providing connection with a network 932 and is a wired or wireless LAN, a Bluetooth (registered trademark) or WUSB communication card, an optical communication router, an ADSL router, or a modem for various communication modes, for example. The network 932 connected to the communication block 926 is configured by a network connected in a wired or wireless manner and is the Internet, home LAN, infrared communication, visible light communication, broadcasting, or satellite communication, for example. It should be noted that LAN is short for Local Area Network, WUSB is short for Wireless USB, and ADSL is short for Asymmetric Digital Subscriber Line.

### (5) Summary

Lastly, the technological contents associated with the embodiments of the invention will be briefly summarized. The technological contents to be described later are applicable to various information processing apparatuses including a PC, a mobile phone, a portable game machine, a portable information terminal, and a car navigation system.

The functional configuration of the above-mentioned information processing apparatus can be expressed as follows. This information processing apparatus has a commercial product acquisition block, a commercial product analysis block, a usage log acquisition block, a log analysis block, and a selection support block that follow. The above-mentioned commercial product acquisition block is configured to acquire the commercial product information associated with commercial products subject to coupons. The above-mentioned commercial product analysis block is configured to analyze each commercial product subject to a coupon on the basis of the commercial product information acquired by the above-mentioned commercial product information acquisition block to relate the coupon of the subject commercial product having related commercial product information. Thus, analyzing commercial products subject to coupons and relating these coupons with each other by use of relationship based on the commercial product information allow the presentation of coupons related with a coupon desired by the user.

The above-mentioned usage log acquisition block is configured to acquire a log of the coupon usage by each user. Further, the above-mentioned log analysis block is configured to analyze the purchase timings of commercial products bought by each user on the basis of the usage log acquired by the above-mentioned usage log acquisition block. The above-mentioned selection support block is configured to predict the next purchase timing of a commercial product from the analysis result obtained by the above-mentioned log analysis block, thereby preferentially presenting, at the next purchase timing, the coupon for a commercial product concerned and the coupons related with this coupon by the above-mentioned commercial product analysis block. The above-mentioned novel configuration allows the presentation of coupons for commercial products that the user buys with a predetermined timing, at that predetermined timing. Further, the above-mentioned novel configuration allows the presentation to the user of commercial products related with a commercial product for the coupon desired by the user, thereby widening the options while taking user's desire into consideration.

### (Remarks)

The above-mentioned coupon management server 100 is merely one example of the coupon selection support apparatus. The above-mentioned coupon analysis module 104 is merely one example of the commercial product analysis block. The above-mentioned communication module 101 is merely one example of the usage log acquisition block. The above-mentioned user analysis module 107 and the above-mentioned selection prediction module 108 are merely examples of the log analysis block. The above-mentioned list generation module 110 is merely one example of the selection support block. The above-mentioned coupon management server 100 is merely one example of a server apparatus. The above-mentioned user terminal 40 is merely one example of a client apparatus. The above-mentioned communication module 101 is merely one example a transmission block. The above-mentioned communication module 401 is merely one example of a reception block or the usage log acquisition block. The above-mentioned user analysis module 405 and the above-mentioned selection prediction module 406 are merely examples of the log analysis block. The above-mentioned list generation module 408 and the above-mentioned output module 409 are merely examples of the selection support block.

While preferred embodiments of the present invention have been described using specific terms, such description is for illustrative purpose, and it is to be understood that changes and variations may be made without departing from the spirit or scope of the following claims.

The present application contains subject matter related to that disclosed in Japanese Priority Patent Application JP 2010-115347 filed in the Japan Patent Office on May 19, 2010, the entire content of which is hereby incorporated by reference.

What is claimed is:

1. A coupon selection support apparatus comprising:
a commercial product information acquisition block configured to acquire commercial product information associated with a commercial product subject to a coupon;
a commercial product analysis block configured to analyze a commercial product subject to a coupon on the basis of the commercial product information acquired by said commercial product information acquisition block to relate coupons of subject commercial products having associated commercial product information with each other;
a usage log acquisition block configured to acquire a coupon usage log of each user;
a log analysis block configured to analyze a purchase timing of a commercial product purchased by each user in the past on the basis of a usage log acquired by said usage log acquisition block; and
a selection support block configured to predict a next purchase timing of said commercial product from a result of the analysis executed by said log analysis block for each user to preferentially present, at said next purchase timing, a coupon for said commercial product and coupons related with said coupon by said commercial product analysis block.

2. The coupon selection support apparatus according to claim 1, wherein said commercial product analysis block detects a group of commercial products including substantially a same expression in said commercial product information to relate a plurality of coupons corresponding to said group of commercial products with each other.

3. The coupon selection support apparatus according to claim 1, wherein said commercial product analysis block detects a first group of commercial products including substantially a same expression in said commercial product information and a second group of commercial products belonging to substantially a same price zone from among said first group of commercial products to relate a plurality of coupons corresponding to said second group of commercial products with each other.

4. The coupon selection support apparatus according to claim 2, wherein said log analysis block analyzes a purchase timing with which each user purchased a commercial product in the past to detect a purchase cycle of a commercial product belonging to said group of commercial products, thereby predicting a next purchase timing of the commercial product belonging to said group of commercial products.

5. The coupon selection support apparatus according to claim 3, wherein said log analysis block analyzes a purchase timing with which each user purchased a commercial product in the past to detect a purchase cycle of a commercial product belonging to said group of commercial products, thereby predicting a next purchase timing of the commercial product belonging to said group of commercial products.

6. A coupon selection support system comprising:
a server apparatus; and
a client apparatus;
said server apparatus having
a commercial product information acquisition block configured to acquire commercial product information associated with a commercial product subject to a coupon,
a commercial product analysis block configured to analyze a commercial product subject to a coupon on the basis of the commercial product information acquired by said commercial product information acquisition block to relate coupons of subject commercial products having associated commercial product information with each other, and
a transmission block configured to transmit information about the coupons related with each other by said commercial product analysis block and commercial product information associated with a commercial product subject to a coupon to a client apparatus; and
said client apparatus having
a reception block configured to receive information about the coupons related with each other by said commercial product analysis block and commercial product information associated with a commercial product subject to a coupon from said server apparatus,
a usage log acquisition block configured to acquire a coupon usage log of each user,
a log analysis block configured to analyze a purchase timing of a commercial product purchased by each user in the past on the basis of a usage log acquired by said usage log acquisition block, and
a selection support block configured to predict a next purchase timing of said commercial product from a result of the analysis executed by said log analysis block for each user to preferentially present, at said next purchase timing, a coupon for said commercial product and coupons related with said coupon by said commercial product analysis block.

7. A coupon selection support method comprising the steps of:
acquiring commercial product information associated with a commercial product subject to a coupon;
analyzing a commercial product subject to a coupon on the basis of the commercial product information acquired at the commercial product information acquisition step to relate coupons of subject commercial products having associated commercial product information with each other;
acquiring a coupon usage log of each user;
analyzing a purchase timing of a commercial product purchased by each user in the past on the basis of a usage log acquired at the usage log acquisition step; and
predicting a next purchase timing of said commercial product from a result of the analysis executed at the log analysis step for each user to preferentially present, at said next purchase timing, a coupon for said commercial product and coupons related with said coupon at the commercial product analysis step.

8. A program for making a computer realize the functions of:
acquiring commercial product information associated with a commercial product subject to a coupon;
analyzing a commercial product subject to a coupon on the basis of the commercial product information acquired by said commercial product information acquisition function to relate coupons of subject commercial products having associated commercial product information with each other;
acquiring a coupon usage log of each user;
analyzing a purchase timing of a commercial product purchased by each user in the past on the basis of a usage log acquired by said usage log acquisition function; and
predicting a next purchase timing of said commercial product from a result of the analysis executed by said log analysis function for each user to preferentially present, at said next purchase timing, a coupon for said commercial product and coupons related with said coupon by said commercial product analysis function.
